(19) United States
(12) Patent Application Publication
(10) Pub. No.: US 2026/0149798 A1
(43) Pub. Date: May 28, 2026

(54) METHOD AND DEVICE FOR PROCESSING STATIC AREAS OF IMMERSIVE VIDEO

(71) Applicants: Electronics and Telecommunications Research Institute, Daejeon (KR); IUCF-HYU (Industry-University Cooperation Foundation Hanyang University), Seoul (KR)

(72) Inventors: Kwan Jung OH, Daejeon (KR); Gwangsoon LEE, Daejeon (KR); Jai Young OH, Seoul (KR); Euee-S. JANG, Seoul (KR); Xin LI, Seoul (KR)

(73) Assignees: Electronics and Telecommunications Research Institute, Daejeon (KR); IUCF-HYU (Industry-University Cooperation Foundation Hanyang University), Seoul (KR)

(21) Appl. No.: 19/177,714

(22) Filed: Apr. 14, 2025

(30) Foreign Application Priority Data
Apr. 15, 2024 (KR) 10-2024-0050340
Apr. 10, 2025 (KR) 10-2025-0046619

(51) Int. Cl. H04N 13/156; H04N 19/597; H04N 19/70

(52) U.S. Cl. CPC H04N 13/156; H04N 19/597; H04N 19/70

(57) ABSTRACT

A method and device for processing immersive video are disclosed. According to one embodiment of the present disclosure, a method performed by a first device may include obtaining background input data and non-background input data; generating a single bit stream based on each of the background input data and the non-background input data; and transmitting the single bit stream to a second device, and the single bit stream may include: i) first atlas data associated with the background input data, ii) second atlas data associated with the non-background input data, iii) a first time point index associated with the first atlas, and iv) a second time point index associated with the second atlas data.

### CROSS-REFERENCE TO RELATED APPLICATIONS

This application claims the benefit of earlier filing date and right of priority to Korean Application No. 10-2024-0050340, filed on Apr. 15, 2024, and, Korean Application No. 10-2025-0046619, filed on Apr. 10, 2025, the contents of which are all hereby incorporated by reference herein in their entirety.

### TECHNICAL FIELD

The present disclosure relates to video processing technology, and more particularly, to a method and apparatus for identifying and processing a static area of an immersive video.

### BACKGROUND

Immersive video is a general term for videos that are produced to provide viewers with an immersive experience. As technologies related to immersive video are developed, 6 DoF (degree of freedom) video, multi-view cameras, virtual reality (VR) technology, and metaverse technology are being developed and applied, and related standard technologies (e.g., MPEG (Moving Picture Experts Group)-I (immersive)) are also being actively discussed.

Here, MPEG-I is a video standard technology for providing more vivid viewing and listening experiences on VR and AR (augmented reality) devices. Through MPEG-I, omnidirectional video technology including rotation and translation as well as x-axis, y-axis, and z-axis movements can be supported and applied.

### SUMMARY

The technical problem of the present disclosure is to provide a method and device for processing a static area of an immersive video.

The technical problem of the present disclosure is to provide a method and device for encoding/decoding a bit stream composed of background/non-background viewpoint indices and background/non-background atlas, in order to efficiently encode and decode background and non-background images.

The technical problems to be achieved in the present disclosure are not limited to the technical tasks mentioned above, and other technical problems not mentioned will be clearly understood by those skilled in the art from the description below.

According to one embodiment of the present disclosure, a method performed by a first device may include obtaining background input data and non-background input data; generating a single bit stream based on each of the background input data and the non-background input data; and transmitting the single bit stream to a second device, and the single bit stream may include: i) first atlas data associated with the background input data, ii) second atlas data associated with the non-background input data, iii) a first time point index associated with the first atlas, and iv) a second time point index associated with the second atlas data.

In addition, the first time point index may be mapped to each of at least one first patch included in the first atlas data, and the second time point index may be mapped to each of at least one second patch included in the second atlas data.

In addition, the first time point index may correspond to information on a point in time at which the at least one first patch is to be projected, and the second time point index may correspond to information on a point in time at which the at least one second patch is to be projected.

In addition, the single bit stream may include at least one syntax, and the at least one syntax may include first metadata associated with the first atlas data and second metadata associated with the second atlas.

In addition, the first metadata may include identification information of the at least one first patch and information related to whether the at least one first patch is associated with the background input data, and the second metadata may include identification information of the at least one second patch and information related to whether the at least one second patch is associated with the non-background input data

In addition, the first metadata may include information related to whether a first frame based on the first atlas data is a static frame, and the second metadata may include information related to whether a second frame based on the second atlas data is a static frame.

In addition, the generating the single bitstream may include encoding the background input data to obtain the first atlas data and the first time point index; and encoding the non-background input data to obtain the second atlas data and the second time point index.

In addition, the generating the single bitstream may includes merging the first atlas data and the second atlas data to generate atlas merge data; and merging the first time point index and the second time point index to generate time point index merge data.

In addition, based on the first time point index and the second time point index, decoding of the first atlas data and the second atlas data may be performed.

According to one embodiment of the present disclosure, the first device may include at least one memory; and at least one processor, and the at least one processor may be configured to: obtain background input data and non-background input data; generate a single bit stream based on each of the background input data and the non-background input data; and transmit the single bit stream to a second device, and the single bit stream may include: i) first atlas data associated with the background input data, ii) second atlas data associated with the non-background input data, iii) a first time point index associated with the first atlas, and iv) a second time point index associated with the second atlas data

In addition, the at least one processor may be configured to: encode the background input data to obtain the first atlas data and the first time point index; and encode the non-background input data to obtain the second atlas data and the second time point index.

In addition, the at least one processor may be configured to: merge the first atlas data and the second atlas data to generate atlas merge data; and merge the first time point index and the second time point index to generate time point index merge data.

According to one embodiment of the present disclosure, a method includes acquiring background input data and non-background input data by a first device; generating a single bit stream by the first device based on each of the background input data and the non-background input data; transmitting the single bit stream by the first device to a second device; and decoding the single bit stream by the second device, and the single bit stream may include: i) first atlas data associated with the background input data, ii) second atlas data associated with the non-background input data, iii) a first time point index associated with the first atlas, and iv) a second time point index associated with the second atlas data.

A system according to one embodiment of the present disclosure may include a first device; and a second device, and the first device may be configured to: obtain background input data and non-background input data by the first device; generate a single bit stream by the first device based on each of the background input data and the non-background input data; and transmit the single bit stream by the first device to the second device; and the single bit stream may include: i) first atlas data associated with the background input data, ii) second atlas data associated with the non-background input data, iii) a first time point index associated with the first atlas, and iv) a second time point index associated with the second atlas data, and the second device may be configured to: decode the first atlas data and the second atlas data based on the first time point index and the second time point index.

The features briefly summarized above with respect to the disclosure are merely exemplary aspects of the detailed description of the disclosure that follows, and do not limit the scope of the disclosure.

According to various embodiments of the present disclosure, a method and apparatus for processing a static region of an immersive video can be provided.

According to various embodiments of the present disclosure, a method and apparatus for encoding/decoding a bit stream comprising background/non-background viewpoint indices and background/non-background atlas can be provided to efficiently encode and decode background and non-background images.

The effects obtainable in the present disclosure are not limited to the effects mentioned above, and other effects not mentioned will be clearly understood by those skilled in the art from the description below.

### BRIEF DESCRIPTION OF THE DRAWINGS

The accompanying drawings included as part of the detailed description to facilitate understanding of the present disclosure provide embodiments of the present disclosure and describe technical features of the present disclosure along with detailed descriptions.

FIG. 1 is a drawing for describing source views for background and non-background that can be applied to the present disclosure.

FIG. 2 is a drawing for describing operations related to source views for background and non-background that can be applied to the present disclosure.

FIG. 3 is a diagram for describing the operation of an encoder for object-based coding according to an embodiment of the present disclosure.

FIG. 4 is a diagram for describing the operation of a decoder for object-based coding according to an embodiment of the present disclosure.

FIG. 5 is a diagram for describing the rendering process of TM and STM that can be applied to the present disclosure.

FIG. 6 is a flowchart for describing a method for processing immersive video according to an embodiment of the present disclosure.

FIG. 7 is a block diagram illustrating a device according to an embodiment of the present disclosure.

### DETAILED DESCRIPTION

Since the present disclosure can make various changes and have various embodiments, specific embodiments are illustrated in the drawings and described in detail in the detailed description. However, this is not intended to limit the present disclosure to specific embodiments, and should be understood to include all modifications, equivalents, and substitutes included in the idea and scope of the present disclosure. Similar reference numbers in the drawings indicate the same or similar function throughout the various aspects. The shapes and sizes of elements in the drawings may be exaggerated for clarity. Detailed description of exemplary embodiments to be described later refers to the accompanying drawings, which illustrate specific embodiments by way of example. These embodiments are described in sufficient detail to enable those skilled in the art to practice the embodiments. It should be understood that the various embodiments are different, but need not be mutually exclusive. For example, specific shapes, structures, and characteristics described herein may be implemented in another embodiment without departing from the idea and scope of the present disclosure in connection with one embodiment. Additionally, it should be understood that the location or arrangement of individual components within each disclosed embodiment may be changed without departing from the spirit and scope of the embodiment. Accordingly, the detailed description set forth below is not to be taken in a limiting sense, and the scope of the exemplary embodiments, if properly described, is limited only by the appended claims, along with all equivalents as claimed by those claims.

In this disclosure, terms such as first and second may be used to describe various components, but the components should not be limited by the terms. These terms are only used for the purpose of distinguishing one component from another. For example, a first element may be termed a second element, and similarly, a second element may be termed a first element, without departing from the scope of the present disclosure. The term and/or includes a combination of a plurality of related recited items or any one of a plurality of related recited items.

When an element of the present disclosure is referred to as being “connected” or “connected” to another element, it may be directly connected or connected to the other element, but it should be understood that other components may exist in the middle. On the other hand, when an element is referred to as “directly connected” or “directly connected” to another element, it should be understood that no other element exists in the middle.

Components appearing in the embodiments of the present disclosure are shown independently to represent different characteristic functions, and do not mean that each component is composed of separate hardware or a single software component. That is, each component is listed and included as each component for convenience of description, and at least two components of each component are combined to form one component, or one component can be divided into a plurality of components to perform functions. An integrated embodiment and a separate embodiment of each of these components are also included in the scope of the present disclosure unless departing from the essence of the present disclosure.

Terms used in the present disclosure are only used to describe specific embodiments, and are not intended to limit the present disclosure. Singular expressions include plural expressions unless the context clearly dictates otherwise. In the present disclosure, terms such as “comprise” or “have” are intended to designate that there are features, numbers, steps, operations, components, parts, or combinations thereof described in the specification, and it should be understood that this does not preclude the possibility of the presence or addition of one or more other features, numbers, steps, operations, components, parts, or combinations thereof. That is, the description of “including” a specific configuration in the present disclosure does not exclude configurations other than the corresponding configuration, and means that additional configurations may be included in the practice of the present disclosure or the scope of the technical spirit of the present disclosure.

Some of the components of the present disclosure may be optional components for improving performance rather than essential components that perform essential functions in the present disclosure. The present disclosure may be implemented including only components essential to implement the essence of the present disclosure, excluding components used for performance improvement, and a structure including only essential components excluding optional components used only for performance improvement is also included in the scope of the present disclosure.

Hereinafter, embodiments of the present disclosure will be described in detail with reference to the drawings. In describing the embodiments of this specification, if it is determined that a detailed description of a related known configuration or function may obscure the gist of the present specification, the detailed description will be omitted. The same reference numerals are used for the same components in the drawings, and redundant descriptions of the same components are omitted.

The system and/or method/device (hereinafter simply referred to as “system”) proposed in the present disclosure relates to a method and device for processing a static area of an immersive video.

Specifically, the present disclosure relates to a method and apparatus for encoding/decoding a bit stream comprising background/non-background viewpoint indices and background/non-background atlases, for efficiently encoding and decoding background and non-background images.

As an example of the present disclosure, foreground and background separation and coding including spatial merge (SM), temporal merge (TM) and/or spatial-temporal merge (STM) can be applied.

In addition, as an example of the present disclosure, a method of reporting the current status and results of spatiotemporal merging of backgrounds can be applied. And, a syntax change can be applied to meet the function of object-based coding in MIV (MPEG Immersive Video) Edition 2.

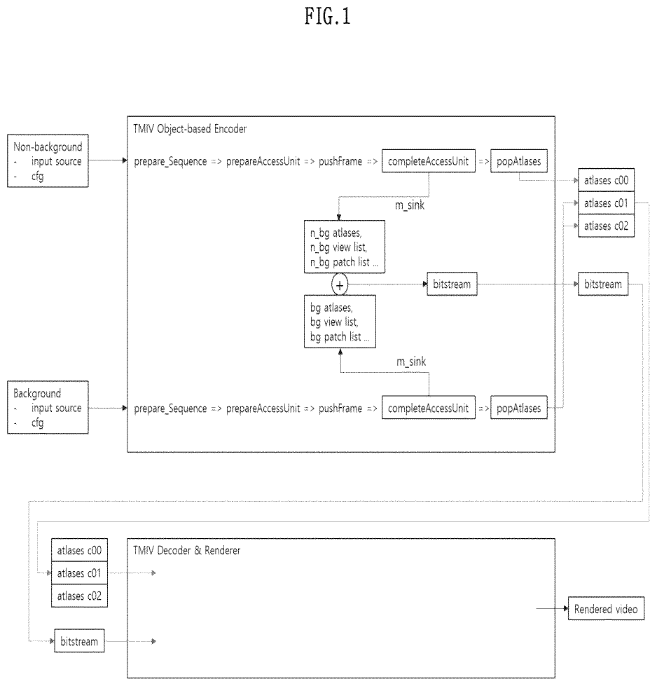

FIG. 1 is a drawing for describing source views for background and non-background that can be applied to the present disclosure.

Specifically, FIG. 1 illustrates the implementation structure of a TMIV (test model for immersive video) encoder, decoder, and renderer for CE1 (i.e., a central experiment related to object-based coding).

As an example of the present disclosure, as illustrated in FIG. 1, separate input sources and configurations for non-background and background can be input to an encoder of the device. Here, the input sources and/or settings for non-background can be collectively referred to as non-background input data, and the input sources and/or settings for background can be collectively referred to as background input data. Through this, an optimization operation can be performed for each non-background environment and background encoding environment.

The device may separately encode each of the non-background input data and the background data. For example, the device may encode the non-background input data to generate a non-background bitstream, and may encode the background input data to generate a background bitstream.

And, the device may merge (or combine) the bitstreams for the non-background bitstream and the background data into one bitstream.

And, the device may merge the bitstreams for the non-background bitstream and the background data into one bitstream.

When the non-background bitstream and the background bitstream are merged into a single bitstream, data such as a view list, a patch list, an atlas list, a tile list, and/or a video-based point cloud compression (V-PCC) parameter set (VPS) may be concatenated.

And, the device may connect the background-related atlas generated by performing separate encoding on the background input data and the non-background-related atlas generated by performing encoding on the non-background input data.

The bitstream and atlas may be passed to the decoder and the renderer. The device may perform decoding and rendering on the bitstream and atlas based on i) whether there is background data or non-background data on each atlas and ii) what the merging method is for the background data.

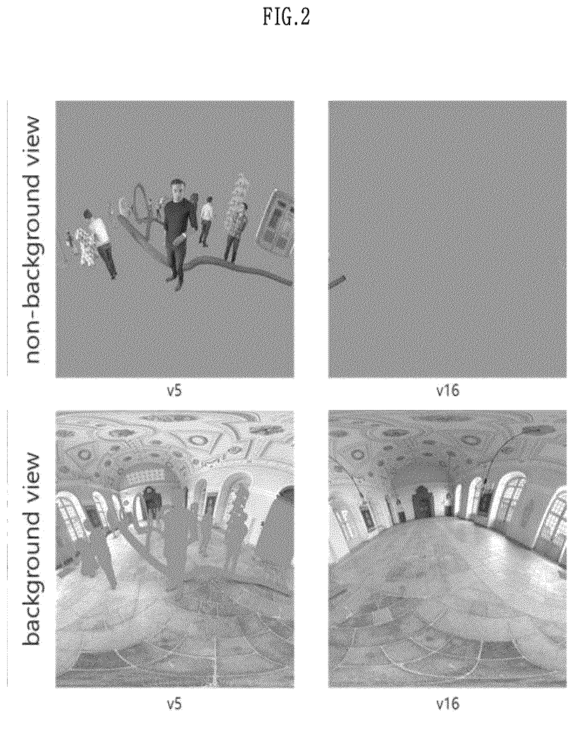

FIG. 2 is a diagram for describing operations related to source viewpoints for background and non-background that can be applied to the present disclosure.

A source view represents a view representation captured by a real or virtual camera in the video material before encoding. As an example of the present disclosure, the device can perform a separation operation of a source view, such as a non-background view and a background view.

Background viewpoint refers to the viewpoint expression when the camera captures the background in space, and non-background viewpoint refers to the viewpoint expression when the camera captures the non-background in space.

Background viewpoints and non-background viewpoints can distinguish whether each patch of the atlas may be projected onto the background or non-background. When the frame rates of the background and non-background are different, such as in time merging, the device may separate the background and non-background through the viewpoint index and then render them.

For example, the background viewpoint and the non-background viewpoint may be transmitted as a single bitstream via concatenation. Additionally or alternatively, the separation of the background viewpoint and the non-background viewpoint may be used for decoding and rendering. The above-described method may be used in various ways depending on how it is handled during the encoding and decoding process.

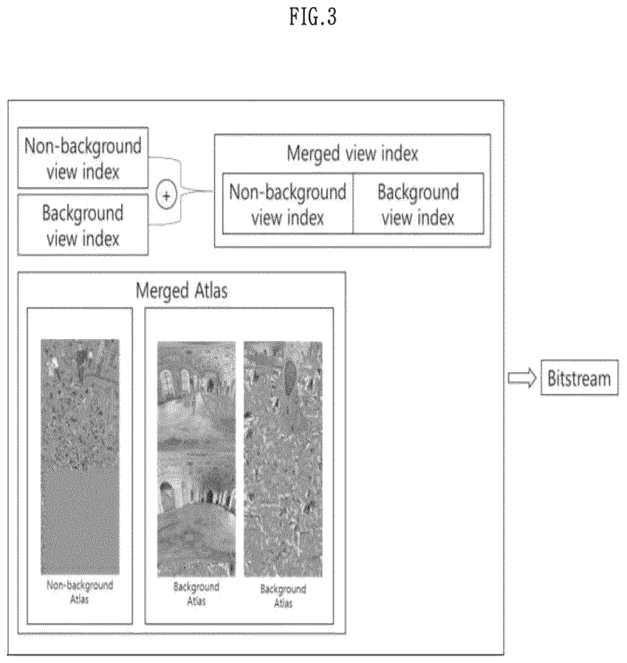

FIG. 3 is a diagram for describing the operation of an encoder for object-based coding according to one embodiment of the present disclosure.

Specifically, FIG. 3 illustrates the concept of merging viewpoint indices and atlases for background data and non-background data into one set on the encoder side for object-based coding.

When encoded background data and non-background data are merged into one (e.g., a single bitstream), the device may transmit the single bitstream. For example, the device may transmit the single bitstream based on the merged viewpoint index (e.g., a merge of a non-background viewpoint index and a background viewpoint index) and the merged atlas (e.g., a merge of a non-background atlas and a background atlas).

For example, each of the non-background atlas and/or the background atlas may include patches. Each patch may include viewpoint index data that determines which viewpoint the patch is projected to.

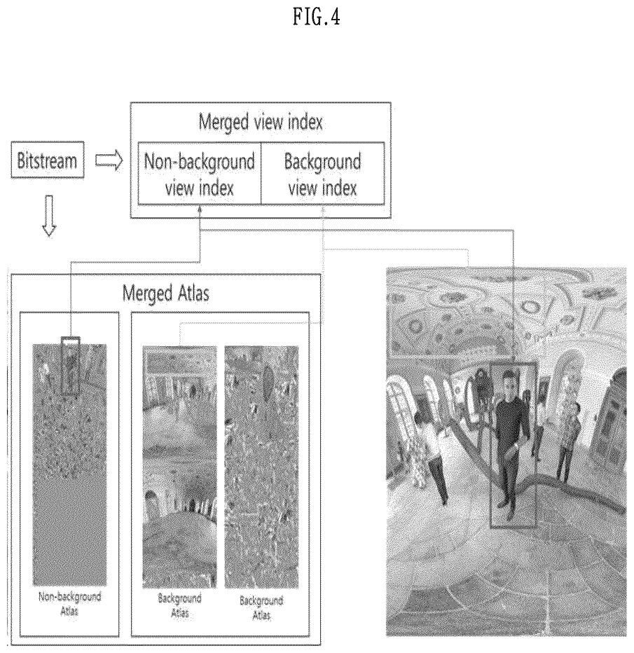

FIG. 4 is a diagram for describing the operation of a decoder for object-based coding according to one embodiment of the present disclosure.

Specifically, FIG. 4 illustrates the concept of decoding and rendering background and non-background separately.

The decoder may distinguish whether the atlas contains background data or non-background data through syntax related to the asps (atlas sequence parameter set) (e.g., syntax including information for identifying the type of data corresponding to the atlas). In addition, the decoder may identify whether temporal merging has been applied to the atlas with background data and/or the frame unit to which the temporal merging has been applied through the syntax.

Each patch may have its own viewpoint index information for the point in time at which it is to be projected. For example, the viewpoint index may determine the point in time at which the patch is to be rendered. This allows the encoder to render separate background and non-background through the background viewpoint index and non-background viewpoint index.

The above-described operation enables decoding and rendering for operations and SMs that do not have temporal merging applied to the background. For data with temporal merging applied to the background, such as TM and STM, additional information may be required for decoding and rendering.

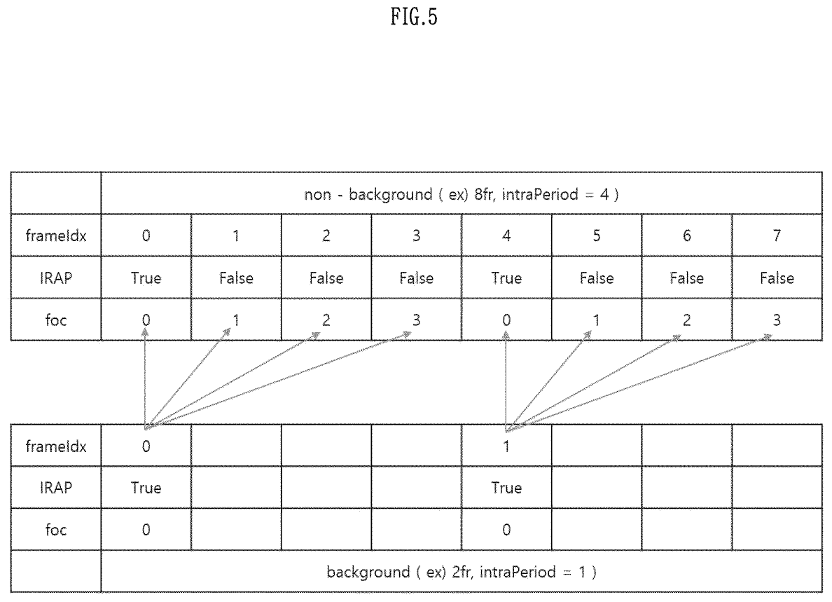

FIG. 5 is a drawing for describing the rendering process of TM and STM that can be applied to the present disclosure.

In TM and STM, non-background data may be rendered as in general rendering. However, for background data, frames corresponding to the length within the period can be temporally merged or spatiotemporally merged into one frame.

While non-background data is rendered on a frame-by-frame basis, background data may only be rendered for the first frame within a period. And, the rendered background frame may be reused without being rendered again within the period. For example, the rendered background frame may be composited with the non-background data.

This allows the device to render background data for only one frame within a period, which can reduce rendering time. In addition, background data composed of a single viewpoint spatially merged based on a central viewpoint can be encoded, which can help reduce encoding time as no pruning process is required.

Hereinafter, the structure and functions/operations of the syntax that the device can transmit and receive are described.

As an example of the present disclosure, Table 1 illustrates an example of the Atlas sequence parameter set MIV Edition 2 extended syntax.

TABLE 1

| | Descriptor |
|---|---|
| asps_miv_2_extension( ) { | |
| asme_patch_margin_enabled_flag | u(1) |
| asme_background_atlas_flag | u(1) |
| if( asme_background_atlas_flag ) { | |
| asme_static_background_flag | u(1) |
| if( asme_static_background_flag ) | |
| asme_static_background_period_minus1 | ue(v) |
| } | |
| } | |
| asme_reserved_zero_8bits | u(8) |
| } | |

As an example of the present disclosure, if “asme_background_atlas_flag” (e.g., flag information indicating whether the atlas is related to a background) is 1, it may specify/mean that the atlas is a background-related atlas.

If “asme_background_atlas_flag” is 0, it may specify/mean that the atlas is not background-related (i.e., the atlas is a non-background-related atlas).

As an example of the present disclosure, if “asme_static_background_flag” is 1, it may specify/mean that the atlas associated with the background is static. In this case, the atlas may be reused for background rendering during the IDR period.

If “asme_static_background_flag” is 0, it may mean/specify that the atlas associated with the background is not static. If “asme_static_background_flag” is absent, the value of asme_static_background_flag may be inferred to be 0.

“asme_static_background_period_minus1+1” can specify/mean the number of frames to be temporally merged for each background atlas.

As an example of the present disclosure, Table 2 relates to the atlas frame parameter set MIV Edition 2 extended syntax.

TABLE 2

| | Descriptor |
|---|---|
| afps_miv_2_extension( ) { | |
| if( asme_background_atlas_flag && static_background_flag ) | |
| afme_static_frame_flag | u(1) |
| } | |

As an example of the present disclosure, if “afme_static_frame_flag” is 1, it may mean/specify that the frame is static.

The frame may be stored in the decoder and used for rendering until the next “afme_static_frame_flag” becomes 1.

If “afme_static_frame_flag” is 0, it may mean/specify that the frame is not a static frame.

“Atlas frame parameter se( )” may exist and be applied, but is not limited to this. A new “afps_miv_2_extension( )” may be created, in which “12 Atlas Frame Parameter Set MIV Edition 2 Extension Syntax” may be defined, and “afme_static_frame_flag” may be defined, which is a syntax that defines whether a frame in an atlas is static.

This syntax may mean that successive frames are temporally static relative to the previous frame with a syntax value of 1 until the next 1 value is reached. This allows successive temporally static frames to be temporally merged and expressed without being encoded at all.

To redefine “afps_miv_2_extension( )”, the above syntax can be added to the upper standard, V3C standard, as follows.

As an example of the present disclosure, Table 3 relates to the atlas frame parameter set RBSP syntax.

TABLE 3

| | |
|---|---|
| afps_miv_extension_present_flag | |
| afps_miv_2_extension_present_flag | u(1) |
| if( afps_miv_extension_present_flag ) | |
| afps_miv_extension( ) | |
| if( afps_miv_2_extension_present_flag ) | |
| afps_miv_2_extension( ) | |

As an example of the present disclosure, when “afps_miv_2_extension_present_flag” is 1, it may mean/specify that the afps_miv_2_extension( ) syntax structure is in the atlas_frame_parameter_set_rbsp( ) syntax structure.

If “afps_miv_2_extension_present_flag” is 0, it may mean/specify that the corresponding syntax structure is not present. If the corresponding syntax structure is not present, the value of “afps_miv_2_extension_present_flag” can be inferred to be 0.

These syntaxes may be defined in the atlas frame parameter set as in the example above, or in a common atlas frame as in the example below.

As an example of the present disclosure, Table 4 relates to the common atlas frame MIV 2 extension syntax.

TABLE 4

Descriptor

```
caf_miv_2_extension( ) {
  if( nal_unit_type == NAL_CAF_IDR ) {
      miv_view_params_list( )
  } else {
  }
    if(casme_background_separation_enable_flag)
came_static_frame_flag
}
```

If “came_static_frame_flag” is 1, it means/can specify that the frame is static. The frame may be stored in the decoder, and used for rendering the next time “came_static_frame_flag” becomes 1.

If “came_static_frame_flag” is 0, it may specify/mean that the frame is not a static frame.

To define caf_miv_2_extension( ) in the same way, the following syntax can be added to the V3C standard.

As an example of the present disclosure, Table 5 relates to common atlas frame RBSP syntax.

TABLE 5

| | |
|---|---|
| caf_miv_2_extension_present_flag | u(1) |
| if( caf_miv_2_extension_present_flag ) | u(7) |
| caf_miv_2_extension( ) | |

As an example of the present disclosure, when “caf_miv_2_extension_present_flag” is 1, it may specify/mean that the “caf_miv_2_extension( )” syntax structure is in the common_atlas_frame_rbsp( ) syntax structure.

If “caf_miv_2_extension_present_flag” is 0, it may specify/mean that the “caf_miv_2_extension( )” syntax structure is not in the common_atlas_frame_rbsp( ) syntax structure. In this case, the value of “caf_miv_2_extension_present_flag” may be inferred to be 0.

Additionally, unlike encoder-side merging, “frame_rendering_skip_flag” for frame skipping during rendering may also be defined on a per-frame basis.

The syntax may be transmitted in the form of metadata in the main stream or in the form of an SEI message.

If the computing power of the rendering on the decoder side is not good, for a frame with a flag value corresponding to “frame_rendering_skip_flag” of 1, the rendering process can be skipped and the previous frame may be copied and used.

As an example of the present disclosure, Table 6 exemplifies afps_miv_2_extension( ).

TABLE 6

| | Descriptor |
|---|---|
| casps_miv_2_extension( ) { | |
| casme_decoder_side_depth_estimation_flag | u(1) |
| casme_chroma_scaling_present_flag | u(1) |
| if( casme_chroma_scaling_present_flag ) | |
| casme_chroma_scaling_bit_depth_minus1 | u(5) |
| casme_capture_device_information_present_flag | u(1) |
| if( casme_capture_device_information_present_flag ) | |
| capture_device_information( ) | |
| casme_background_separation_enabled_flag | u(1) |
| casme_frame_rendering_skip_enabled_flag | u(1) |
| casme_reserved_zero_8bits | u(8) |
| } | |

As an example of the present disclosure, if “casme_frame_rendering_skip_enabled_flag” is 1, it may indicate that a frame rendering skip related parameter is present in the syntax structure.

If “casme_background_separation_enabled_flag” is 0, this may indicate that there is no frame rendering skip related parameter in the syntax structure. In this case, the value of “casme_frame_rendering_skip_enabled_flag” can be inferred to be 0.

As an example of the present disclosure, Table 7 illustrates afps_miv_2_extension( ).

TABLE 7

| | Descriptor |
|---|---|
| afps_miv_2_extension( ) { | |
| if(casme_frame_rendering_skip_enabled_flag) | |
| afme_frame_rendering_skip_ flag | u(1) |
| } | |

If “afme_frame_rendering_skip_flag” is 1, it may specify/mean that frames may be skipped in the rendering process.

Skipped frames may be copied from previous frames. If “afme_frame_rendering_skip_flag” is 0, it may specify that frames cannot be skipped in the rendering process.

Additionally, as described below, a flag may also be defined to determine whether a point in time is static or not at the viewpoint level. The following flag may be used to determine whether the point in time is background or not.

As an example of the present disclosure, Table 8 relates to the MIV point-in-time parameter list syntax.

TABLE 8

| | Descriptor |
|---|---|
| afps_miv_2_extension( ) { | |
| if(casme_frame_rendering_skip_enabled_flag) | |
| afme_frame_rendering_skip_ flag | u(1) |
| } | |

For example, if “mvp_static_view_background_flag[v]” is 1, it can mean/specify that the point in time with index v is a static background point in time.

The point in time may be retained for rendering during the IDR period. If “mvp_static_view_background_flag[v]” is 0, it may mean/specify that the point in time with index v is not a static background point in time.

For example, if “mvp_static_view_background_flag[v]” does not exist, the value of mvp_static_view_background_flag[v] may be inferred to be 0.

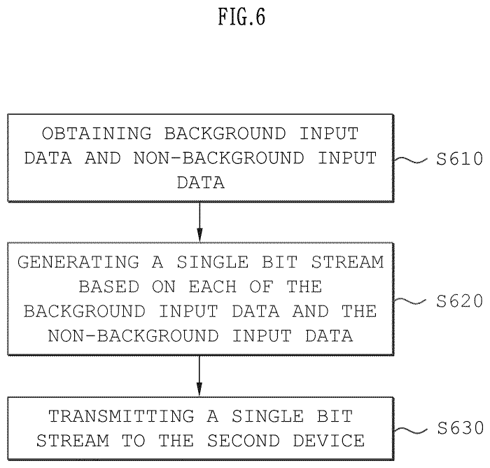

FIG. 6 is a flowchart illustrating a method of processing immersive video according to one embodiment of the present disclosure.

In FIG. 6, the first device may collectively refer to a device on the encoder side (e.g., a device including an encoder that encodes background input data and non-background input data into a single stream). And, the second device may collectively refer to a device on the decoder side (e.g., a device including a decoder that decodes a single stream).

The encoder of the first device and the decoder of the second device may perform multiple operations according to FIGS. 1 to 5.

The first device may obtain background input data and non-background input data (S610).

Here, the background input data may include background input data according to at least one point in time (e.g., source point in time) and configuration information related to the background input data (e.g., viewpoint information for each image constituting the background input data, etc.).

And, the non-background input data may include non-background input data according to at least one point in time (e.g., source point in time) and configuration information related to the non-background input data (e.g., image-specific point-in-time information constituting the non-background input data, etc.).

As an example of the present disclosure, the first device may extract background input data and non-background input data from an image (e.g., an immersive video). Additionally or alternatively, the first device may receive background input data and non-background input data related to the image from another device.

The first device may generate a single bit stream based on each of the background input data and the non-background input data (S620).

For example, the first device may encode background input data to obtain first atlas data and a first time point index. Then, the first device may encode non-background input data to obtain second atlas data and a second time point index.

Here, a first time point index may be mapped to each of at least one first patch included in the first atlas data. And, a second time point index may be mapped to each of at least one second patch included in the second atlas data.

And, the first time point index may correspond to information about the time point and/or position at which at least one first patch is to be projected. The second time point index may correspond to information about the location and/or time point at which at least one second patch is to be projected.

The first device may generate atlas merge data by merging the first atlas data and the second atlas data. Further, the first device may generate time point index merge data by merging the first time point index and the second time point index. The first device may generate a single bit stream through the atlas merge data and the time point index merge data.

That is, a single bit stream may include i) first atlas data associated with background input data, ii) second atlas data associated with non-background input data, iii) a first time point index associated with the first atlas, and iv) a second time point index associated with the second atlas data.

Additionally, the single bit stream may include at least one syntax. The at least one syntax may include, but is not limited to, a first time point index and a second time point index. The first time point index and the second time point index may be included on the single bit stream separately from the at least one syntax.

For example, at least one syntax may include first metadata associated with the first atlas data and second metadata associated with the second atlas.

For example, the first metadata may include identification information of at least one first patch and information regarding whether at least one first patch is associated with background input data.

Additionally, the second metadata may include identification information of at least one second patch and information regarding whether at least one second patch is associated with non-background input data.

Additionally or alternatively, the first metadata may include information regarding whether the first frame based on the first atlas data is a static frame.

Additionally, the second metadata may include information regarding whether the second frame based on the second atlas data is a static frame.

Additionally or alternatively, at least one syntax may include at least one of Tables 1 to 8.

The first device may transmit a single bit stream to the second device (S630).

The second device may decode a single bit stream. Specifically, the second device can decode the first atlas data and the second atlas data based on the first time point index and the second time point index.

For example, the second device may perform rendering and decoding for at least one first patch based on time point information at which at least one first patch corresponding to the first time point index is to be projected. That is, the second device may perform rendering through the projection time point and/or position of the first patch.

The second device may perform rendering and decoding for at least one second patch based on information about a point in time at which at least one second patch corresponding to a second point in time index is to be projected. That is, the second device may perform rendering through the projection point in time and/or position of the second patch.

Additionally or alternatively, the second device may identify information related to the first atlas data and the second atlas data through at least one syntax within a single bit stream. The second device may decode the first atlas data and the second atlas data based on the identified information. As an example, the second device may perform a decoding operation according to the manner illustrated in FIGS. 1 to 5.

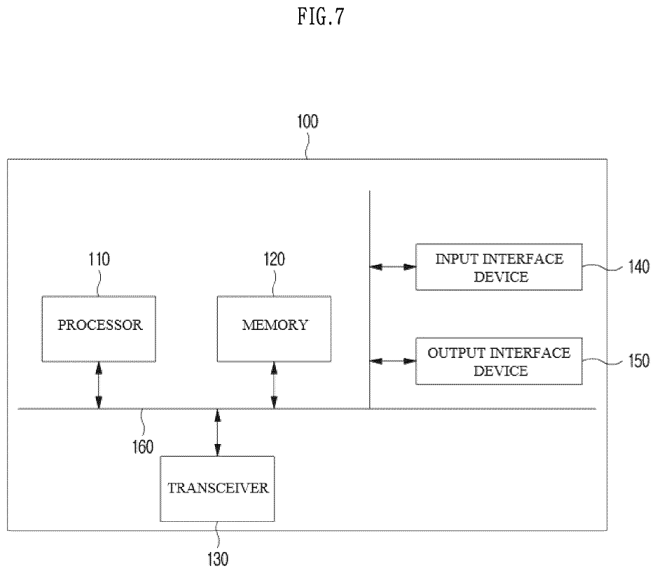

FIG. 7 is a block diagram illustrating a device according to an embodiment of the present disclosure.

The device (100) illustrated in FIG. 7 may collectively refer to the first device and the second device described with reference to FIGS. 1 to 6. That is, the device (100) may mean a device used in the present disclosure.

The device (100) may include at least one of a processor (110), a memory (120), a transceiver (130), an input interface device (140), and an output interface device (150). Each of the components may be connected to each other by a common bus (160). In addition, each of the components may be connected to each other through an individual interface or individual bus centered on the processor (110), rather than the common bus (160).

The processor (110) may be implemented in various types such as an AP (Application Processor), a CPU (Central Processing Unit), a GPU (Graphic Processing Unit), etc., and may be any semiconductor device that executes a command stored in the memory (120). The processor (110) may execute a program command stored in the memory (120). The processor (110) may obtain an image of a specific river based on the above-described FIGS. 1 to 6.

The processor (110) may include one or more modules for automatically monitoring frequency.

And/or, the processor (110) may store program instructions for implementing at least one function for one or more modules in the memory (120) to control the operations described based on FIGS. 1 to 6 to be performed.

The memory (120) may include various forms of volatile or non-volatile storage media. For example, the memory (120) may include read-only memory (ROM) and random access memory (RAM). In an embodiment of the present disclosure, the memory (120) may be located inside or outside the processor (110), and the memory (120) may be connected to the processor (110) through various means already known.

The transceiver (130) may perform a function of transmitting and receiving data processed/to be processed by the processor (110) with an external device and/or an external system.

For example, the transceiver (130) may be utilized for data exchange with other terminal devices, etc.

The input interface device (140) may be configured to provide data to the processor (110).

The output interface device (150) may be configured to output data from the processor (110).

Components described in the exemplary embodiments of the present disclosure may be implemented by hardware elements. For example, The hardware element may include at least one of a digital signal processor (DSP), a processor, a controller, an application specific integrated circuit (ASIC), a programmable logic element such as an FPGA, a GPU, other electronic devices, or a combination thereof. At least some of the functions or processes described in the exemplary embodiments of the present disclosure may be implemented as software, and the software may be recorded on a recording medium. Components, functions, and processes described in the exemplary embodiments may be implemented as a combination of hardware and software.

The method according to an embodiment of the present disclosure may be implemented as a program that can be executed by a computer, and the computer program may be recorded in various recording media such as magnetic storage media, optical reading media, and digital storage media.

Various techniques described in this disclosure may be implemented as digital electronic circuits or computer hardware, firmware, software, or combinations thereof. The above techniques may be implemented as a computer program product, that is, a computer program or computer program tangibly embodied in an information medium (e.g., machine-readable storage devices (e.g., computer-readable media) or data processing devices), a computer program implemented as a signal processed by a data processing device or propagated to operate a data processing device (e.g., a programmable processor, computer or multiple computers).

Computer program(s) may be written in any form of programming language, including compiled or interpreted languages. It may be distributed in any form, including stand-alone programs or modules, components, subroutines, or other units suitable for use in a computing environment. A computer program may be executed by a single computer or by a plurality of computers distributed at one or several sites and interconnected by a communication network.

Examples of information medium suitable for embodying computer program instructions and data may include semiconductor memory devices (e.g., magnetic media such as hard disks, floppy disks, and magnetic tapes), optical media such as compact disk read-only memory (CD-ROM), digital video disks (DVD), etc., magneto-optical media such as floptical disks, and ROM (Read Only Memory), RAM (Random Access Memory), flash memory, EPROM (Erasable Programmable ROM), EEPROM (Electrically Erasable Programmable ROM) and other known computer readable media. The processor and memory may be complemented or integrated by special purpose logic circuitry.

A processor may execute an operating system (OS) and one or more software applications running on the OS. The processor device may also access, store, manipulate, process and generate data in response to software execution. For simplicity, the processor device is described in the singular number, but those skilled in the art may understand that the processor device may include a plurality of processing elements and/or various types of processing elements. For example, a processor device may include a plurality of processors or a processor and a controller. Also, different processing structures may be configured, such as parallel processors. In addition, a computer-readable medium means any medium that can be accessed by a computer, and may include both a computer storage medium and a transmission medium.

Although this disclosure includes detailed descriptions of various detailed implementation examples, it should be understood that the details describe features of specific exemplary embodiments, and are not intended to limit the scope of the invention or claims proposed in this disclosure.

Features individually described in exemplary embodiments in this disclosure may be implemented by a single exemplary embodiment. Conversely, various features that are described for a single exemplary embodiment in this disclosure may also be implemented by a combination or appropriate sub-combination of multiple exemplary embodiments. Further, in this disclosure, the features may operate in particular combinations, and may be described as if initially the combination were claimed. In some cases, one or more features may be excluded from a claimed combination, or a claimed combination may be modified in a sub-combination or modification of a sub-combination.

Similarly, although operations are described in a particular order in a drawing, it should not be understood that it is necessary to perform the operations in a particular order or order, or that all operations are required to be performed in order to obtain a desired result. Multitasking and parallel processing can be useful in certain cases. In addition, it should not be understood that various device components must be separated in all exemplary embodiments of the embodiments, and the above-described program components and devices may be packaged into a single software product or multiple software products.

Exemplary embodiments disclosed herein are illustrative only and are not intended to limit the scope of the disclosure. Those skilled in the art will recognize that various modifications may be made to the exemplary embodiments without departing from the spirit and scope of the claims and their equivalents.

Accordingly, it is intended that this disclosure include all other substitutions, modifications and variations falling within the scope of the following claims.

What is claimed is:

1. A method performed by a first device, the method comprising:
obtaining background input data and non-background input data;
generating a single bit stream based on each of the background input data and the non-background input data; and
transmitting the single bit stream to a second device,
wherein the single bit stream includes: i) first atlas data associated with the background input data, ii) second atlas data associated with the non-background input data, iii) a first time point index associated with the first atlas, and iv) a second time point index associated with the second atlas data.

2. The method of claim 1, wherein:
the first time point index is mapped to each of at least one first patch included in the first atlas data, and
the second time point index is mapped to each of at least one second patch included in the second atlas data.

3. The method of claim 2, wherein:
the first time point index corresponds to information on a point in time at which the at least one first patch is to be projected, and
the second time point index corresponds to information on a point in time at which the at least one second patch is to be projected.

4. The method of claim 3, wherein:
the single bit stream includes at least one syntax, and
the at least one syntax includes first metadata associated with the first atlas data and second metadata associated with the second atlas.

5. The method of claim 4, wherein:
the first metadata includes identification information of the at least one first patch and information related to whether the at least one first patch is associated with the background input data, and
the second metadata includes identification information of the at least one second patch and information related to whether the at least one second patch is associated with the non-background input data.

6. The method of claim 4, wherein:
the first metadata includes information related to whether a first frame based on the first atlas data is a static frame, and
the second metadata includes information related to whether a second frame based on the second atlas data is a static frame.

7. The method of claim 1, wherein:
the generating the single bitstream includes:
encoding the background input data to obtain the first atlas data and the first time point index; and
encoding the non-background input data to obtain the second atlas data and the second time point index.

8. The method of claim 7, wherein:
the generating the single bitstream includes:
merging the first atlas data and the second atlas data to generate atlas merge data; and
merging the first time point index and the second time point index to generate time point index merge data.

9. The method of claim 1, wherein:
based on the first time point index and the second time point index, decoding of the first atlas data and the second atlas data is performed.

10. A first device comprising:
at least one memory; and
at least one processor,
wherein the at least one processor is configured to:
obtain background input data and non-background input data;
generate a single bit stream based on each of the background input data and the non-background input data; and
transmit the single bit stream to a second device,
wherein the single bit stream includes: i) first atlas data associated with the background input data, ii) second atlas data associated with the non-background input data, iii) a first time point index associated with the first atlas, and iv) a second time point index associated with the second atlas data.

11. The first device of claim 10, wherein:
the first time point index is mapped to each of at least one first patch included in the first atlas data, and
the second time point index is mapped to each of at least one second patch included in the second atlas data.

12. The first device of claim 11, wherein:
the first time point index corresponds to information on a point in time at which the at least one first patch is to be projected, and
the second time point index corresponds to information on a point in time at which the at least one second patch is to be projected.

13. The first device of claim 12, wherein:
the single bit stream includes at least one syntax, and
the at least one syntax includes first metadata associated with the first atlas data and second metadata associated with the second atlas.

14. The first device of claim 13, wherein:
the first metadata includes identification information of the at least one first patch and information related to whether the at least one first patch is associated with the background input data, and
the second metadata includes identification information of the at least one second patch and information related to whether the at least one second patch is associated with the non-background input data.

15. The first device of claim 13, wherein:
the first metadata includes information related to whether a first frame based on the first atlas data is a static frame, and
the second metadata includes information related to whether a second frame based on the second atlas data is a static frame.

16. The first device of claim 10, wherein the at least one processor is configured to:
encode the background input data to obtain the first atlas data and the first time point index; and
encode the non-background input data to obtain the second atlas data and the second time point index.

17. The first device of claim 16, wherein the at least one processor is configured to:
merge the first atlas data and the second atlas data to generate atlas merge data; and
merge the first time point index and the second time point index to generate time point index merge data.

18. The first device of claim 10, wherein:
based on the first time point index and the second time point index, decoding of the first atlas data and the second atlas data is performed.

19. A method comprising:
acquiring background input data and non-background input data by a first device;
generating a single bit stream by the first device based on each of the background input data and the non-background input data;
transmitting the single bit stream by the first device to a second device; and
decoding the single bit stream by the second device,
wherein the single bit stream includes: i) first atlas data associated with the background input data, ii) second atlas data associated with the non-background input data, iii) a first time point index associated with the first atlas, and iv) a second time point index associated with the second atlas data.
